(19) United States
(12) Patent Application Publication
(10) Pub. No.: US 2010/0083975 A1
(43) Pub. Date: Apr. 8, 2010

(54) Rotary Nailcare Device with Mandrel Bit for Nail Shaping, Filing, and Polishing

(75) Inventors: Phong H. Nguyen, San Gabrielle, CA (US); Chung Quoc Nguyen, Westminster, CA (US)

Correspondence Address: Klein, O''Neill & Singh, 43 Corporate Park, Suite 204, Irvine, CA, 92606, US

(73) Assignee: SOFI NAILS, INC., Garden Grove, CA (US)

(21) Appl. No.: 12/247,182

(22) Filed: Oct. 7, 2008

(51) Int. Cl. A45D 29/00; A45D 29/18; A45D 29/04; A45D 29/05; B23B 39/16; B23B 51/00

(52) U.S. Cl. 132/200; 132/75.4; 132/75.6; 132/75.8; 132/76.4; 408/117; 408/199; 132/73.6

(57) ABSTRACT

A nail care system and method using a rubber or soft plastic coated mandrel bit connected to a rotary device, the mandrel bit reducing vibration during operation of the nail care system allowing for smoother polishing and filing as well as a more comfortable experience for the client and nail care practitioner.

### FIELD OF THE INVENTION

This invention generally relates to nail care products, and in particular to a rotary device and mandrel bit for filing, sanding, shaping and polishing nails.

### BACKGROUND OF THE INVENTION

The cosmetic industry enjoyed unparalleled growth in recent years fueled by rising salaries and reduced leisure time. Nail salons are positively booming as people with more disposable income, find less and less time to take care of their beauty needs. Fortunately, they have utilized a part of their newfound wealth to patronize nail salons with greater frequency. A typical nail salon customer may visit their favorite salon every week for complete nail care.

Complete nail care includes such services as trimming, shaping, smoothing, polishing, and painting to perfection all twenty nails. This painstaking labor, which once took most of an afternoon, can now be done by a professional in less than twenty minutes. Saving time, getting perfect nails, and perhaps being pampered for a short time, are all reasons why nail salons are more and more popular.

As with any industry that affects the general public, certain standards are required to keep the public safe. Title 16 Division 9 §981(a) of the California Code of Regulations Board of Barbering and Cosmetology require that:
a) All instruments and supplies which come into direct contact with a patron and cannot be disinfected (for example, cotton pads, sponges, emery boards, and neck strips) shall be disposed of in a waste receptacle immediately after use.

Sanitation requirements like these prevent the spread of communicable diseases such as warts, fungus, ring worms, and other skin afflictions spread by contact. As one can imagine, due to the sheer volume of customers patronizing a nail salon, even one contaminated nail tool can infect dozens of customers.

It is thus apparent that the need exists for a rotary working bit which is cost effective to manufacture, and complies with sanitary regulations. Such a tool would necessarily be disposable or capable of sterilization, yet less expensive than the current art.

### SUMMARY OF THE INVENTION

A system for shaping and filing nails comprising an electric rotary device, a control unit, and a working bit. The working bit performs a variety of nail care functions and varies in shape and size. Each working bit when rotated by the rotary device is designed to perform a particular function such as cutting, filing, sanding, polishing, and grinding. In one embodiment of the invention, the working bit may be a mandrel bit with a soft plastic or rubber head attached to a shaft of metal. Vanes of soft plastic or rubber run the length of the mandrel bit head. These vanes may aid in securing a sanding band and also reduce vibration during use. This innovative nail care system reduces vibration, fatigue, and cost effectively complies with safety regulations and health codes.

### BRIEF DESCRIPTION OF THE DRAWINGS

FIG. 1 is an electric rotary device and control unit.

FIG. 2 is side view of a representative example of a mandrel bit.

FIG. 3 is a side view of a representative example of a mandrel bit with the mandrel bit shaft shown in detail.

FIG. 4 is a perspective view of a mandrel with a sanding band positioned prior to placement on the mandrel bit.

FIG. 5 is a head on view of a mandrel bit with sanding band attached.

### DETAILED DESCRIPTION OF THE INVENTION

To shape and polish nails, nail care professionals use many cutting and filing tools, including an electric rotary device with interchangeable working bits. Electric rotary devices are light weight hand held electrically powered tools. The electric rotary device operates by spinning a working bit at high speeds.

The electric rotary device may employ an electric motor to rotate an output shaft at high speeds. Clutch and transmission may be utilized to alter the rate of rotation and prevent gear stripping. Gear stripping may occur if the electric rotary device over torques when the working bit encounters an unusually hard surface or is otherwise prevented from rotating freely. The output shaft may be detachably coupled to the shaft of a working bit to impart spin on the working bit.

A working bit is a detachable implement generally comprising a head attached to a shaft. The head generally performs a working function when rotated. For example, the head may be a sanding head and when rotated sands or polishes a surface. The shaft of a working bit is securely fastened to the head or in some embodiments the shaft and head are cast or molded as one unit. A working bit may include cutting bits, sanding bits, filing bits, polishing bits, among others. For the purpose of this application the term working bit may be applied to any detachable nail care implement used in conjunction with an electric rotary device.

The shaft may be detachably attached to the electric rotary device by way of a clamp or collet. The method of gripping the working bit shaft will be explained in more detail below. Generally the shaft or a working bit may be made of a hard material such as metal, plastic, or composite, to withstand the torque imparted by the electric rotary device.

Professional grade electric rotary nail files may operate in excess of 35,000 RPMs. The high spin rate produced by professional electric rotary nail files may cause vibration at the working bit. Vibration is a primary complaint for both customers and nail care practitioners alike. Vibration is undesirable because it can cause discomfort to the client and the nail care practitioner. Furthermore, excess vibration may decrease the accuracy of the nail care practitioner. For example, if a filing bit is excessively vibrating, it may be difficult for the nail care practitioner to gauge how much pressure to apply to smooth, shape, or polish a nail. The finished nail may therefore be rougher or misshapen due to excess vibration. Furthermore, continuous vibration may cause hand fatigue and joint pain to the nail care practitioner, limiting the amount of time a nail care practitioner may work each day.

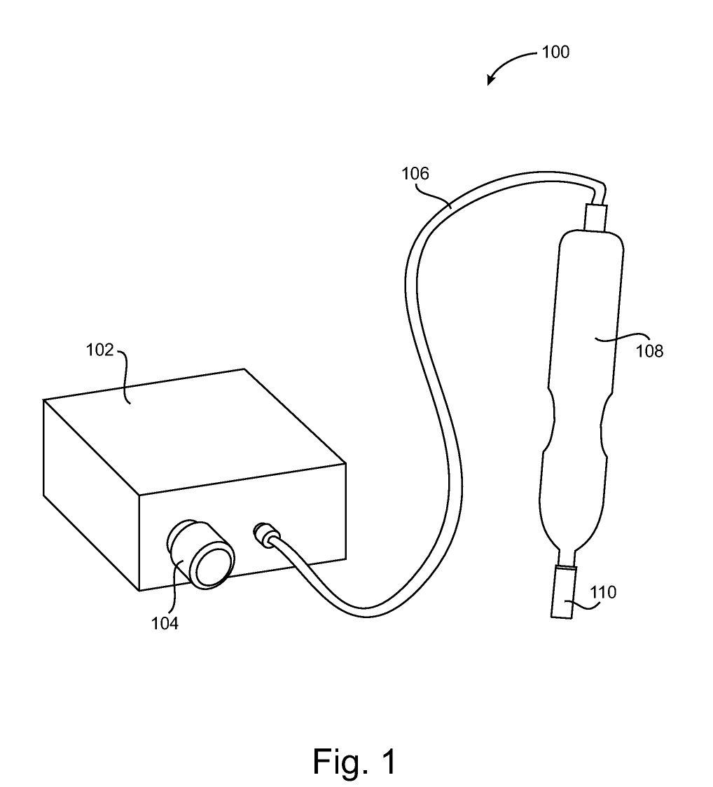

FIG. 1 depicts one embodiment of the nail care system 100, comprising control unit 102, speed selector 104, control cord 106, handheld rotary device 108, and working bit 110. This system as described is only for purposes of illustration. Minor modification to the system such as incorporating the control unit within the handheld rotary device 108 is within the scope of this application. Other modifications such as a battery operated rotary nail care device are also contemplated and incorporated within the scope of this application.

The handheld rotary device 108 of the electric nail file may be an ergonomic cylinder shaped device with a corded connection at the back end connecting it to a power source and control unit 102. The front end of the device is designed to hold the various working bits 110 which may be used to shape, polish, or file nails. Housed within the cylinder is a rotary electric motor which uses direct current to impart torque onto an output shaft. Different types of electric motors including alternating current electric motors may be used in various embodiments of this invention without altering the nature of the invention.

The attachment for holding the working bit 110 may be adjustable to accommodate different size shafts found on different working bits 110. Shafts may range from 1/32 to ⅛ inches in diameter but may also come in different metric sizes depending where the articles are manufactured and utilized. Such an attachment should be capable of holding the shaft securely while the working bit 110 is rotating at high speeds. This task is further complicated because the shaft of working bit 110 may be made of a rod of smooth stainless steel. A smooth shaft is easier to manufacture and may be less costly to manufacture as opposed to a shaft with beveled sides, however, a smooth shaft is harder to grip securely because of a smaller gripping surface and reduced friction.

In one embodiment of the invention, the shaft of a working bit is held by a circular vice grip or keyless chuck. A keyless chuck uses a plurality of jaws to hold the shaft of a bit. The pluralities of jaws are tightened around the shaft by a sleeve ring operatively connected to the jaws. Rotation of the sleeve ring in one direction causes either an opening or closing of the jaws. Rotation in the opposite direction will cause an opposite movement of the jaws. For instance, if a clockwise rotation of the sleeve ring closes the jaws, then a counterclockwise rotation would open them. As the name suggests, a keyless chuck does not require a key. All components necessary to remove and replace working bit 110 are attached to the keyless chuck. This may be advantageous especially in a busy working environment because there are no small components to lose. It is also generally desirable for keyless chuck assemblies to be operable by hand strength alone. A hand tightened keyless chuck allows for efficient removal and replacement of filing bits during a nail session, reducing undue delays to the client.

In an alternative embodiment, a collet and collet nut are used to detachably secure the shaft of a working bit 110. The collet is a hollow cylinder with a tapered head. The collet is split most of its length into four sections forming four prongs connected by the unsplit section. The collet nut is placed over the collet and held in place by screw threads. The collet nut is hollow, allowing the shaft of the working bit 110 to be placed in between the four prongs. When the collet nut is tightened, the four prongs are pushed together, thereby holding the working bit 110 securely in place.

Utilizing collets or keyless chucks, a nail care practitioner may swiftly change the working bit 110. The ability to change working bit 110 swiftly may be desirable for two reasons. First, time spent changing a working bit may be better utilized helping other clients. Secondly, with the myriad of working bits available for specialized tasks, the ability to change working bits on the fly equates to more customized nail care.

The handheld rotary device 108 is may be cylindrically shaped with a tapered front end and rounded back end. The size and weight of the rotary device 108 is such that the rotary device 108 may fit comfortably within the palm of the nail care technician. Alternative embodiments of rotary devices 108 are ergonomically shaped, including molded plastic forms contoured to comfortably fit the practitioner's hand. The rotary device 108 varies in length but is generally between six and eight inches long to easily maneuver around nails.

The back end of a handheld rotary device 108 connects to a control cord 106 which conducts both electricity and control signals. The control cord 106 is durably made and insulated by a nonconductive plastic or rubber covering. The control cord 106 may be coiled to increase the overall length of the cord and extend the reach of the practitioner. A coiled control cord 106 is also less likely to become tangled. In a busy environment such as a salon, tangled cords may pose a trip hazard or fire hazard.

On the other end of the insulated control cord 106 is the control unit 102, used to adjust the speed of rotation of the working bit. In one embodiment, the control unit 102 includes a speed selector 104. The speed selector 104 may be a dial switch or slide switch capable of making minute changes in rotation speed. Minute adjustments in rotation speed may be useful for detailed polishing and shaping of the nails. For example a dial switch or slide switch may have a setting of low, medium, medium high and high. Similarly the speed selector 104 may be marked numerically to represent the rate of rotation, with a lower number corresponding to a slower rate and a higher number corresponding to a higher rate of rotation.

The rotary nail care system 100 is illustrated as a corded electric drill, however, any portable electric rotary power tool is contemplated within the scope and spirit of the invention. The rotary device 108 includes an electric motor housed within an ergonomically shaped hand sized cylinder. The motor has a rotary output shaft for providing an output torque. The motor is connected to a power source for imparting rotation to the rotary output shaft. Such a power source may be a direct current power supply or an alternating current power supply. In the representative embodiment the power source is housed within and combined with the control unit 102. The control unit 102 may also include a switch for opening and closing the circuit between the power supply and the motor, thus allowing a user to selectively turn the device on and off.

In one embodiment the rotary device 108 includes a transmission for reducing the rotation speed of the output provided by the motor. The transmission reduces the rate of rotation and increases the output torque to the rotary nail care device. Greater output torque may be useful for filing nails while higher rotation speed may be more useful for polishing nails. A tool receptacle or chuck is affixed to the rotary output shaft for retaining a working bit and consequently imparting a torque thereto. The control unit 102 includes a multiple speed selector switch in communication with the transmission allowing a user to select multiple output speeds of the rotary tool. In one embodiment, the rotary device 108 may also include a clutch for preventing an excessive load on the motor to prevent motor burnout or over torque.

Working bits 110 are attached via the tool receptacle to the rotary device 108. The torque from the output shaft is transferred to the working bit 110, allowing the working bit to perform numerous functions. Working bits 110 may include filing bits, sanding bits, and shaping bits, which comes in various sizes and shapes. Working bits 110 may be made of a hard metal, with the body being a cylinder shaped shaft also referred to as a shank. The shank or shaft may have a variable diameter ranging between 1/32 of an inch to ¼ of an inch. In the alternative, the shaft may also be sized in metrics ranging between 0.1 mm -7 mm. While the above exemplary sizes are described, the shaft may be of any reasonable size without being outside the scope of this application. The head of the working bit may be one of several useful shapes, such as rounded knobs, acorn shaped knobs, and cylindrical knobs. The head of the working bit may be coated with an abrasive such as diamonds, synthetic diamonds, silicon carbide, and aluminum oxide. When rotated at high speeds, this abrasive coating abrades the surface of the nail it is applied to. The amount of nail removed depends upon the speed of rotation, grit size, and force applied to the nail. Slower speed, fine grain grit, and delicate application of the rotating bit will result in a smoother and more polished nail.

An abrasive surface may also be scored into the head of a metallic working bit 110. Ridges cut into the metallic surface of a filing bit create a cutting surface. When rotated at high speeds this cutting surface will remove material it contacts. Depending on the size and sharpness of the ridges, metallic working bits may be used to shape nails or polish them. The metal composing a working bit 110 may also determine the useful lifespan of that implement. Metal working bits 110 may be composed of any hard metal, such as stainless steel, aluminum, carbide, and tungsten. Harder and more expensive metal working bits 110 such as carbide and tungsten can last a very long time when properly cared for.

An all metal working bit is durable but eventually the abrasive coating that allows the metal bit to perform its sanding functions will wear out. Furthermore, a metal working bit may be difficult to completely sanitize as required by health codes. Some health codes require that any implement contacting a nail care customer be autoclaved or discarded. The durable body of a metallic working bit may withstand the high temperatures of an autoclave, but the abrasive coating may not be capable of repeated autoclaving. The disinfectants used in most autoclaving machines have a corrosive effect and may eventually weaken the abrasive coating.

A scored working bit, wherein the abrasive surface is cut into the metal to create a file may be more autoclave resistant, but is still not ideally suited for commercial nail care use. One deficiency of the scored working bit is that nail debris may remain lodged in the cutting edges of the working bit 110. A stiff bristle must be applied to dislodge the nail debris between customers. Cleaning each grooved metal working bit by hand is time consuming and may not result in satisfactory sanitation. Again, time spent cleaning a working bit may be more lucratively spent servicing other clients. Generally soaking an implement in a disinfectant will destroy more germs and bacteria than brushing the same implement with a disinfectant. Unfortunately, soaking alone will not remove the embedded nail debris. Furthermore some health care regulations may prohibit cleaning as a method of disinfection. Working bits may have to be discarded after each customer.

Thus the simple solution is to simply discard the working bit 110 after each use. As with most regulations, there is a cost of compliance. A typical nail care session may use several different types to shape and smooth the nail. Beginning with the more abrasive variety and ending with a fine grit or fine ridged rotary filing bit. A typical nail appointment costs about $10.00. If even three rotary filing bits costing approximately $1.00 each are used, profit margins are heavily impacted. Furthermore this cost cannot be passed through to client, because at some point, the price will outweigh the convenience of professional nail care.

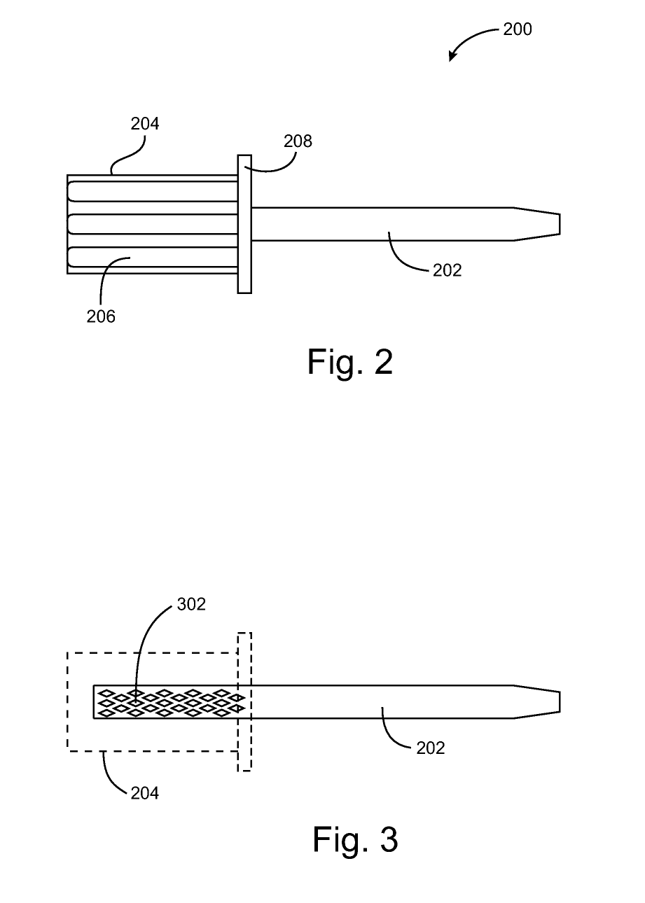

A possible solution to the problems of sanitation versus cost may be achieved by utilizing inexpensively made sanding bands coupled to a mandrel bit. In one embodiment of the invention, mandrel bit 200 is uniquely designed for holding a sanding or polishing band. The mandrel bit 200, shown in FIG. 2, is illustrated with two component sections; shaft 202 and head 204. Shaft 202 may be composed of any hard substance which can withstand torque from the electric motor housed within the rotary device. In one embodiment, stainless steel is used in the manufacture of shaft 202, because of its durability and ability to be molded into different intricate forms. Another advantage to stainless steal is the metal's ability to withstand heat and cleansing compounds. Stainless steel may be subjected to autoclaving in a sanitizing fluid. Less durable material may corrode or warp under the heat and extreme pH conditions rendering the mandrel bit unusable.

Moving to FIG. 3 an illustration of the shaft as seen with the mandrel head removed. The shaft head 302 is encased by the mandrel head 204. In this illustration, the section of shaft 202 underneath the mandrel head 204 is referred to as shaft head 302. In one embodiment of the invention, shaft head 302 is not smooth like the rest of the shaft 202. Shaft head 302 may have small diamond shaped protrusions formed during the manufacturing process. The protrusions create a rough surface enabling the soft plastic or rubber head 204 of the mandrel bit to better adhere to the shaft. The diamond shaped protrusions may prevent the mandrel head 204 from rotating around the shaft head 302. During use, the mandrel head 204 will experience torque and if attached to a smooth rod, the mandrel head 204 may separate from the shaft 202. As illustrated in this embodiment, the protrusions may be diamond shaped, but it is understood that protrusions of other shapes and sizes may be substituted. Alternatively, scoring the shaft 202 at the area of attachment to head mandrel 204 to create a rougher surface may also suffice.

During manufacturing the mandrel head 204 is molded onto the shaft 202. Injection molding of the mandrel head 204 assures a tight fit with the shaft 202 which may prevent the separation of the mandrel head 204 from the shaft 202 during use. Other method of manufacture may include insertion of the shaft 202 into the mandrel head 204 before the soft plastic or rubber is set in the mold. Adhesive may also be used to attach mandrel head 204 to shaft 202. Other methods of attaching the mandrel head 204 to the shaft 202 may be apparent to one of ordinary skill in the art and should be considered part of this application.

Moving back to FIG. 2, the mandrel head 204 also includes a hilt 208 and vanes 206. The hilt 208 is a circular ring at the base of the mandrel head 204. The hilt 208 may be formed of the same substance as the mandrel head. Generally the hilt 208 is one or two millimeters larger than the diameter of the rest of the mandrel head 204 and is attached in a plane perpendicular to the longitudinal axis of the mandrel head 204 and at the base of the aforementioned mandrel head 204. When a sanding band is attached to the mandrel bit 204, the hilt 208 may prevent the sanding band from sliding past the mandrel head 204. Most sanding bands are no more than one millimeter in thickness, thus a hilt may should be sufficiently large to prevent a sanding band from sliding past the hilt and off the mandrel head.

Vanes 206 are narrow lengths of soft rubber or plastic extending radially from the mandrel head 204. During manufacture the vanes 206 may be injection molded along with the rest of mandrel head 204. As mentioned previously the mandrel head 204 may be attached to the shaft 202 during the injection molding process to form a single unitary mandrel bit 200. When a sanding band is placed over the vanes 206, the vanes 206 may cushion the sanding band and lessen vibration throughout the system. Furthermore the vanes 206 may also keep the sanding band from rotating about the mandrel head 204.

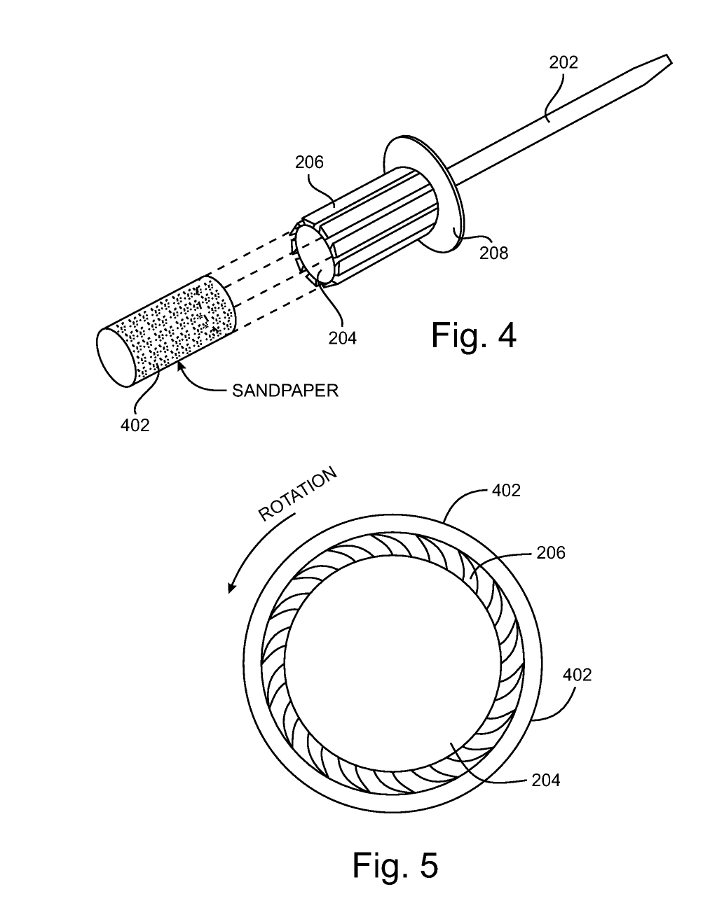

In FIG. 4, a sanding band 402 is shown just prior to placement on a mandrel head 204. Sanding band 402 is a hollow cylinder which may be made of a stiff paper or plastic material. The outer surface of sanding band 402 is an abrasive surface which may be formed of diamonds, synthetic diamonds, silicon carbide, and aluminum oxide. The abrasive dust may be glued onto the outer surface of sanding band 402 to form an abrasive surface, or the sanding band 402 may be powder coated with fine abrasive particles during manufacture.

As mentioned previously, certain health regulations may mandate the disposal of any instrument which contacts the skin of a client unless the instrument can be thoroughly disinfected. It may be cost effective to use sanding band 402 in conjunction with mandrel bit 200 instead of metallic working bits because sanding band 402 may be disposable. Each sanding band 402 costs pennies as opposed to several dollars for a well made carbide metallic working bit. Furthermore, simple removal and disposal is more sanitary than reuse and is also less time consuming.

To insert sanding band 402 onto mandrel head 200, sanding band 402 is first orientated as shown in FIG. 4, along the longitudinal axis of the mandrel head 204. Sand band 402 is then inserted onto the mandrel head 204 until stopped by the hilt 208. The diameter of sanding bit 402 is only slightly larger than the diameter of the mandrel head 204, resulting in a snug fit. When the mandrel head 204 is rotated, the snug fit of sanding band 402 on mandrel head 204 may reduce or eliminate rotation of the sanding band about the mandrel head 204. Vanes 206 radially deployed around the circumference of the mandrel head 204 in a longitudinal orientation may also reduce or eliminate unwanted counter rotation of the sanding band 402.

FIG. 4 and FIG. 5 illustrate vanes 206 in more detail. Uniquely designed vanes 206 may be pliable blades of rubber or soft plastic attached to the mandrel head 204. In one embodiment, the vanes 206 are injection molded out of the same material as mandrel head 204. As illustrated in FIG. 5, vanes 206 are attached along one longitudinal side to the body of mandrel head 204. Furthermore they are regularly spaced around the circumference of mandrel head 204. The non bound longitudinal side of vane 204 may end at a curved point forming a crest proximal to the next adjacent vane 206.

In FIG. 5, the sanding band 402 is shown covering the mandrel head 204. The vanes 206 contact the inner surface of the sanding band preventing the sanding band 402 from rotating about the mandrel head 204. As viewed from this perspective, the direction of rotation of the mandrel bit head 204 is counterclockwise. The sanding bit 402 may tend to rotate in the opposite direction especially when the sanding band 402 contacts a nail surface. As depicted in FIG. 5, the vanes 206 rotating in a counterclockwise motion will push their leading edge against the inner surface of the sanding bit 402. Because the vanes are formed of a soft plastic or rubber, they will deform slightly under pressure. Some may even bend backward slightly causing more outward pressure between the vanes 206 and the sanding band 402. More surface area of vane 206 will contact the inner surface of sanding band 402 resulting in an even better hold on sanding band 404.

The pliable nature of vanes 206 may also act to cushion the sanding band 402 and lessen vibration. Each vane 206 may compress slightly under pressure and act as independent shock absorbers.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains

What is claimed:

1. A nail care system comprising;
a working bit adapted to perform filing, sanding, polishing, cutting, or grinding functions on a nail;
a rotary device adapted to detachably secure the working bit and impart rotational moment to the working bit using an electric motor housed within the rotary device; and
a control unit adapted to provide power to the rotary device and to control the rate of rotation imparted by the rotary device

2. The nail care system of claim 1, wherein the working bit is made of a hard metal or plastic and further comprises a head attached to a shaft between 1/32 and ⅛ of an inch in diameter.

3. The nail care system of claim 1, wherein the working bit is a mandrel bit further comprising a hard shaft and a head of rubber or soft plastic, the head further comprising vanes for securing and cushioning a sanding band.

4. A nail care system comprising;
a working bit adapted to perform filing, sanding, polishing, cutting, or grinding functions on a nail;
a rotary device adapted to detachably secure the working bit and impart rotational moment to the working bit using an electric motor housed within the rotary device; and
a control unit adapted to provide power to the rotary device and to control the rate of rotation imparted by the rotary device.
wherein the working bit is a mandrel bit further comprising a hard shaft and a head of rubber or soft plastic, the head further comprising vanes for securing and cushioning a sanding band.

5. The nail care system of claim 4, wherein the control unit comprises a dial or slider switch for selecting the rate of rotation of the working bit.

6. The nail care system of claim 4, wherein the electric motor housed in the rotary device is capable of rotating the working bit between 5,000 and 45,000 RPM.

7. The nail care system of claim 4, wherein the rotary device is a variable speed rotary device powered by an electric motor.

8. The nail care system of claim 4, wherein the working bit is detachably secured by a plurality of prongs operatively connected to a ring for tightening or loosening the prongs.

9. The nail care system of claim 4, wherein the working bit is detachably secured by a plurality of prongs tightened by a collet nut.

10. A mandrel bit comprising;
a shaft composed of a hard material; and
a head connected to the shaft,
wherein a section of the shaft attached to the head contains a plurality of protrusions for securing the head to the shaft;
wherein the head is made of a rubber or soft plastic and further comprises a plurality of vanes attached to the head and a circular hilt at the base of the head.

11. The mandrel bit of claim 10, wherein the plurality of vanes is attached to the head along one longitudinal side.

12. The mandrel bit of claim 10, wherein the plurality of vanes is slightly curved at the edge not attached to the head.

13. The mandrel bit of claim 10, wherein the plurality of vanes curves in the opposite direction to the direction of rotation of the mandrel bit.

14. The mandrel bit of claim 10, wherein the section of the shaft attached to the head is scored to create a relatively rough section for attaching the head.

15. The mandrel bit of claim 10, wherein the shaft is made of stainless steel with a diameter between 1/32 and ⅛ of an inch.

16. A method for sanding and filing nails, the method comprising;
attaching a mandrel bit to a rotary device;
attaching a sanding band to the mandrel bit by sliding the sanding band over the top of the mandrel bit until the sanding band contacts a circular hilt at the base of the mandrel bit;
powering the rotary device and selecting a rotation speed appropriate for nail polishing, sanding, shaping, or filing;
applying the rotating sanding band or polishing band to the nail or nails requiring polishing, sanding, shaping or filing; and
removing and disposing the used sanding or polishing band.

17. The method of claim 16, wherein the mandrel bit is removably attached to the rotary device by placing the shaft of the mandrel bit between prongs on the rotary device and tightening the prongs about the shaft.

18. The method of claim 16, wherein the mandrel bit is secured to the rotary device by placing the shaft within a collet, and tightening a collet nut until the mandrel bit is securely fastened.

19. The method of claim 16, wherein the sanding band or polishing band is replaced by sliding the sanding or polishing band off the mandrel bit, discarding of the used sanding or polishing band and replacing with a new sanding or polishing band.
